(19) United States
(12) Patent Application Publication
(10) Pub. No.: US 2024/0265709 A1
(43) Pub. Date: Aug. 8, 2024

(54) ANOMALY DETECTION DEVICE, ANOMALY DETECTION METHOD, AND COMPUTER PROGRAM FOR DETECTING ANOMALY

(71) Applicant: TOYOTA JIDOSHA KABUSHIKI KAISHA, Toyota-shi Aichi-ken (JP)

(72) Inventors: Wataru Kawashima, Nisshin-shi Aichi-ken (JP); Keita Sato, Edogawa-ku Tokyo-to (JP); Takehiko Hanada, Hiratsuka-shi Kanagawa-ken (JP); Soichiro Oura, Chofu-shi Tokyo-to (JP)

(73) Assignee: TOYOTA JIDOSHA KABUSHIKI KAISHA, Toyota-shi Aichi-ken (JP)

(21) Appl. No.: 18/433,954

(22) Filed: Feb. 6, 2024

(30) Foreign Application Priority Data
Feb. 8, 2023 (JP) 2023-017528

(51) Int. Cl. G06V 20/58; B60W 60/00; G06V 20/56

(52) U.S. Cl. CPC G06V 20/58; G06V 20/588; B60W 60/001; B60W 2420/403

(57) ABSTRACT

An anomaly detection device includes a processor configured to identify a path region in an image representing surroundings of a vehicle, the path region representing a host vehicle lane on which the vehicle is traveling, extract a feature indicating the condition of a road surface regarding the path region from the image by inputting the path region in the image into a feature extractor that has been trained to extract the feature, and detect an abnormal condition in which the vehicle is unable to travel normally on the host vehicle lane, when the feature is outside a normal range that is a tolerable range in which the vehicle is able to travel normally.

### CROSS-REFERENCE TO RELATED APPLICATIONS

This application claims priority to Japanese Patent Application No. 2023-017528 filed Feb. 8, 2023, the entire contents of which are herein incorporated by reference.

### FIELD

The present disclosure relates to an anomaly detection device, an anomaly detection method, and a computer program for detecting an anomaly on the basis of an image representing the surroundings of a vehicle.

### BACKGROUND

A technique has been proposed in which a region suitable for travel of vehicles is determined on the basis of an image obtained by an imaging device mounted on a vehicle, and the result of determination is used for autonomous driving control of the vehicle or assistance in driving (see Japanese Unexamined Patent Publication JP2019-211822A).

A travel region determining device described in JP2019-211822A determines a specific region in an image of the surroundings of a vehicle, which is captured by an imaging device, with a machine learning model that has machine-learned multiple images whose subjects are known as road surfaces. Specifically, the travel region determining device determines whether the specific region is a region suitable for travel of vehicles. Thus, for example, a region where an obstacle may be present is determined as a region unsuitable for travel of vehicles. The specific region determined by the travel region determining device is in a travel lane of vehicles in the image.

### SUMMARY

An obstacle, such as a fallen object, lying on the path of a vehicle may be an object of indefinite color, shape, and size, and thus may not be detected accurately even with a classifier for detecting a predetermined object from an image. This may make it difficult to accurately determine whether the road surface on the path of the vehicle is travelable by the vehicle.

It is an object of the present disclosure to provide an anomaly detection device capable of detecting an anomaly that would prevent normal travel of a vehicle.

According to an embodiment, an anomaly detection device is provided, which includes a processor configured to: identify a path region in an image representing surroundings of a vehicle, the path region representing a host vehicle lane on which the vehicle is traveling, extract a feature indicating the condition of a road surface regarding the path region from the image by inputting the path region in the image into a feature extractor that has been trained to extract the feature, detect an abnormal condition in which the vehicle is unable to travel normally on the host vehicle lane, when the feature is outside a normal range that is a tolerable range in which the vehicle is able to travel normally.

The processor of the anomaly detection device extracts the feature by inputting an area in the path region below the bottom of a vehicle-ahead region into the feature extractor, the vehicle-ahead region representing a vehicle traveling ahead of the vehicle.

According to another embodiment, an anomaly detection method is provided. The anomaly detection method includes identifying a path region in an image representing surroundings of a vehicle, the path region representing a host vehicle lane on which the vehicle is traveling; extracting a feature indicating the condition of a road surface regarding the path region from the image by inputting the path region in the image into a feature extractor that has been trained to extract the feature; and detecting an abnormal condition in which the vehicle is unable to travel normally on the host vehicle lane, when the feature is outside a normal range that is a tolerable range in which the vehicle is able to travel normally.

According to still another embodiment, a non-transitory recording medium that stores a computer program for detecting an anomaly is provided. The computer program includes instructions causing a processor mounted on a vehicle to execute a process including identifying a path region in an image representing surroundings of the vehicle, the path region representing a host vehicle lane on which the vehicle is traveling; extracting a feature indicating the condition of a road surface regarding the path region from the image by inputting the path region in the image into a feature extractor that has been trained to extract the feature; and detecting an abnormal condition in which the vehicle is unable to travel normally on the host vehicle lane, when the feature is outside a normal range that is a tolerable range in which the vehicle is able to travel normally.

The anomaly detection device according to the present disclosure has an effect of being able to detect an anomaly that would prevent normal travel of a vehicle.

### BRIEF DESCRIPTION OF DRAWINGS

FIG. 1 schematically illustrates the configuration of a vehicle control system equipped with an anomaly detection device.

FIG. 2 illustrates the hardware configuration of an electronic control unit, which is an embodiment of the anomaly detection device.

FIG. 3 is a functional block diagram of a processor of the electronic control unit, related to a vehicle control process including an anomaly detection process.

FIG. 4 illustrates an example of the anomaly detection process according to the embodiment.

FIG. 5 is an operation flowchart of the vehicle control process including the anomaly detection process.

### DESCRIPTION OF EMBODIMENTS

An anomaly detection device, an anomaly detection method executed by the anomaly detection device, and a computer program for detecting an anomaly will now be described with reference to the attached drawings. The anomaly detection device identifies a path region representing a lane on which a host vehicle is traveling (hereafter a “host vehicle lane”) in an image representing the surroundings of the vehicle generated by an image capturing unit mounted on the vehicle. In addition, the anomaly detection device extracts a feature indicating the condition of a road surface by inputting the path region in the image into a feature extractor. The anomaly detection device determines whether the extracted feature is within a normal range in which the vehicle is able to travel normally, and detects an abnormal condition in which the vehicle is unable to travel normally on the host vehicle lane, when the feature is outside the normal range.

The state in which a vehicle is able to travel normally on a host vehicle lane refers to a state in which the vehicle can travel without decelerating at more than a predetermined deceleration or steering by more than a predetermined amount to avoid hitting an obstacle. The obstacle is, for example, a three-dimensional structure that should not be present on the road surface, such as an object fallen on the road surface, or a stepped defect of the road surface, such as a pothole formed in the road surface.

The following describes an example in which the anomaly detection device is applied to a vehicle controller.

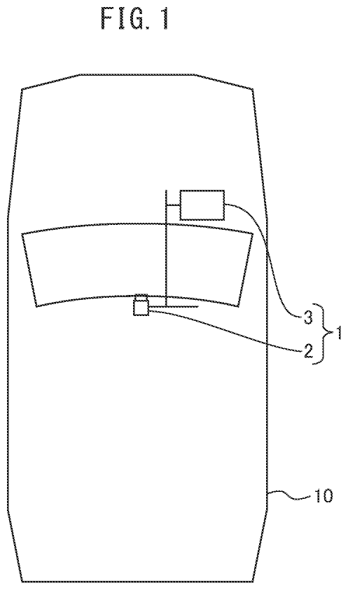

FIG. 1 schematically illustrates the configuration of a vehicle control system equipped with the anomaly detection device. The vehicle control system 1 is mounted on a vehicle 10 and controls the vehicle 10. To achieve this, the vehicle control system 1 includes a camera 2 and an electronic control unit (ECU) 3, which is an example of the anomaly detection device. The camera 2 is communicably connected to the ECU 3 via an in-vehicle network conforming to a communication standard, such as a controller area network. The vehicle control system 1 may include a range sensor (not illustrated) that measures the distances from the vehicle 10 to objects around the vehicle 10, such as LiDAR or radar. The vehicle control system 1 may further include a measurement device (not illustrated) for measuring the position of the vehicle 10 on the basis of signals from satellites, such as a GPS receiver; a navigation device (not illustrated) for searching for a planned travel route to a destination; and a storage device (not illustrated) that stores map information referred to in autonomous driving control of the vehicle 10.

The camera 2 is an example of the image capturing unit that generates an image representing the surroundings of the vehicle 10. The camera 2 includes a two-dimensional detector constructed from an array of optoelectronic transducers, such as CCD or C-MOS, having sensitivity to visible light and a focusing optical system that forms an image of a target region on the two-dimensional detector. The camera 2 is mounted, for example, in the interior of the vehicle 10 so as to be oriented to the front of the vehicle 10. The camera 2 takes pictures of a region in front of the vehicle 10 every predetermined capturing period (e.g., 1/30 to 1/10 seconds), and generates an image representing the region. Each image obtained by the camera 2 may be a color or grayscale image. The vehicle 10 may include two or more cameras taking pictures in different orientations or having different focal lengths.

Every time an image is generated, the camera 2 outputs the generated image to the ECU 3 via the in-vehicle network.

The ECU 3 is configured to execute autonomous driving control of the vehicle 10 under a predetermined condition.

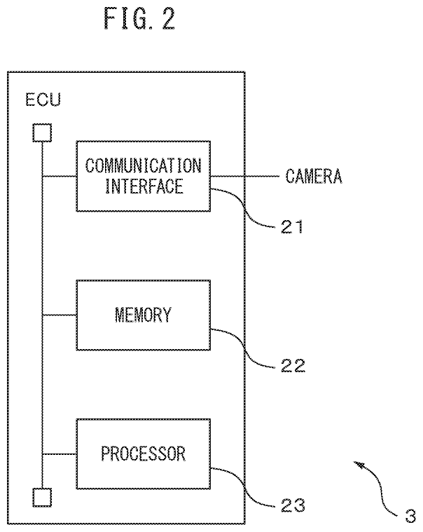

FIG. 2 illustrates the hardware configuration of the ECU 3, which is an example of the anomaly detection device. As illustrated in FIG. 2, the ECU 3 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 3 and the camera 2. Every time an image is received from the camera 2, the communication interface 21 passes the received image to the processor 23.

The memory 22, which is an example of a storage unit, includes, for example, volatile and nonvolatile semiconductor memories, and stores various types of data used in a vehicle control process including an anomaly detection process and executed by the processor 23 of the ECU 3. For example, the memory 22 stores parameters for specifying a classifier used for detecting a path region and a feature extractor used for extracting a feature indicating the condition of a road surface. The memory 22 further stores a normal range of the feature that is a tolerable range in which the vehicle 10 is able to travel normally. In addition, the memory 22 temporarily stores images received from the camera 2 and various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10.

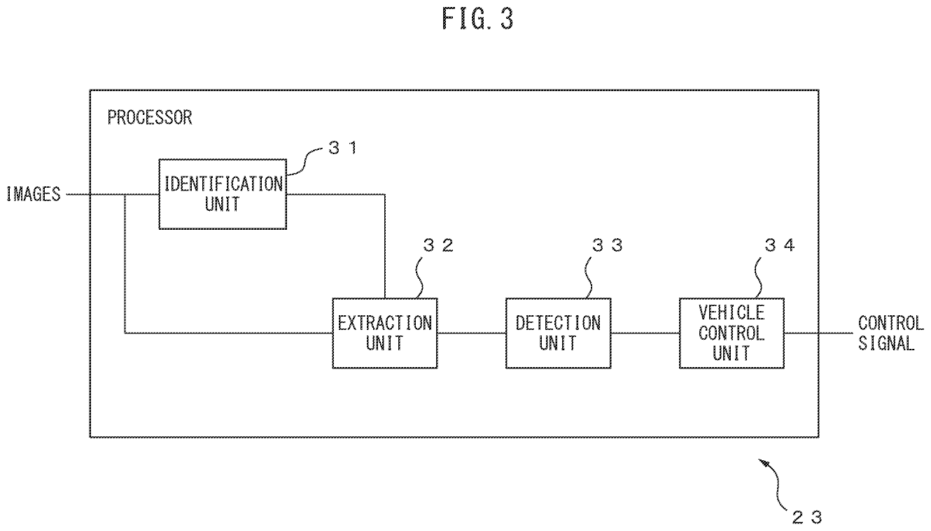

FIG. 3 is a functional block diagram of the processor 23, related to the vehicle control process including an anomaly detection process. The processor 23 includes an identification unit 31, an extraction unit 32, a detection unit 33, and a vehicle control unit 34. These units included in the processor 23 are functional modules, for example, implemented by a computer program executed by the processor 23, or may be dedicated operating circuits provided in the processor 23. Of these units, the identification unit 31, the extraction unit 32, and the detection unit 33 relate to the anomaly detection process.

The identification unit 31 identifies a path region representing a host vehicle lane at predetermined intervals in the latest image received by the ECU 3 from the camera 2.

For example, the identification unit 31 identifies a path region by inputting an image obtained from the camera 2 into a classifier that has been trained to identify a path region. As such a classifier, the identification unit 31 can use a deep neural network (DNN) having architecture of a convolutional neural network (CNN) type. More specifically, a DNN for semantic segmentation that identifies, for each pixel, an object represented in the pixel, e.g., a fully convolutional network (FCN) or U-net, is used as the classifier. Alternatively, the identification unit 31 may use a classifier for semantic segmentation based on a machine learning technique other than a neural network, such as a random forest, as the classifier. The classifier is trained in advance in accordance with a predetermined training technique, such as backpropagation, with a large number of training images representing path regions.

The identification unit 31 determines a set of pixels outputted by the classifier and supposed to represent the host vehicle lane as a path region.

Alternatively, instead of using a classifier like that described above, the identification unit 31 may detect two lane-dividing lines demarcating the host vehicle lane from an image by image analysis, and determine a region sandwiched between the two detected lane-dividing lines as a path region. In general, a lane-dividing line has a color (white or yellow) brighter than the road surface therearound. Thus, pixels representing a lane-dividing line in an image have higher luminance values than pixels representing the road surface therearound. In view of this, the identification unit 31 extracts pixels having luminance values not less than a predetermined value in an area supposed to represent the road surface in an image. Alternatively, the identification unit 31 may extract a pixel having a higher luminance value of two pixels adjacent in the horizontal direction between which the difference in luminance is not less than a predetermined threshold. The identification unit 31 then detects individual lane-dividing lines by approximating sets of extracted pixels with straight lines, and determines the lane-dividing lines closest to the center of the image in the left and right sides of the image as the lane-dividing lines demarcating the host vehicle lane.

In addition, the identification unit 31 may identify a region representing another vehicle traveling just ahead of the vehicle 10 on the host vehicle lane (hereafter a “vehicle-ahead region”) in the image. When a path region is identified using a classifier for semantic segmentation as described above, the classifier may be trained in advance so that the classifier also identifies regions representing other vehicles. Of the regions representing other vehicles, the identification unit 31 determines a region overlapping the path region and being lowest in the image as a vehicle-ahead region. In this way, the identification unit 31 can identify a vehicle-ahead region as well as a path region by inputting an image into the classifier. When a path region is identified by image analysis, the identification unit 31 may detect other vehicles traveling in the vicinity of the vehicle 10 and represented in the image by inputting the image into a vehicle detector that has been trained to detect a vehicle from an image. Of the regions representing the detected vehicles, the identification unit 31 determines a region overlapping the path region and being lowest in the image as a vehicle-ahead region. As such a vehicle detector, the identification unit 31 can use, for example, a DNN for object detection, such as Single Shot MultiBox Detector or Faster R-CNN. Such a vehicle detector is trained in advance in accordance with a predetermined training technique, such as backpropagation, with a large number of training images representing vehicles to be detected.

Every time a path region is detected from an image, the identification unit 31 notifies the extraction unit 32 of information indicating the path region. When a vehicle-ahead region is detected from an image, the identification unit 31 also notifies the extraction unit 32 of information indicating the vehicle-ahead region. The information indicating the path region may be, for example, an image that is the same size as the original image and in which pixels inside the path region and pixels outside the path region have different values. The same holds true for the information indicating the vehicle-ahead region.

The extraction unit 32 extracts a feature indicating the condition of a road surface (the feature will be referred to as a “surface condition feature” below) from the path region in the image. To achieve this, the extraction unit 32 inputs the path region in the image into a feature extractor that has been trained to extract a surface condition feature. The feature extractor is configured, for example, by a DNN having architecture of a CNN type including convolution layers, such as VGG16 or VGG19. The feature extractor may also include one or more fully-connected layers closer to the output side than the convolution layers. A feature map outputted from the convolution layer closest to the output side (alternatively, the convolution layer closest to the output side and another of the convolution layers closer to the input side than the layer) is used as a surface condition feature outputted by the feature extractor. A surface condition feature outputted by the feature extractor is expressed, for example, as a feature vector having one or more element values.

The feature extractor is trained in advance in accordance with a predetermined training technique, such as backpropagation, with a large number of images each representing some of various types of objects as well as a road surface so that these objects can be classified. In this way, various types of information represented in an image are condensed into a surface condition feature. This enables the feature extractor to output a surface condition feature indicating the condition of the road surface represented in a path region.

Alternatively, a DNN trained in advance by “unsupervised learning,” such as Auto-encoder or Stacked what-where auto-encoders, may be used as the feature extractor. In this case, the feature extractor includes, in order from the input side, an encoder that outputs a feature having a lower dimension than inputted data (in the present embodiment, a path region) and a decoder into which the feature outputted from the encoder is inputted. The feature extractor is trained in advance with a large number of images like those described above so that data outputted from the decoder is the same as data inputted into the encoder. By inputting a path region into the trained feature extractor, a surface condition feature is obtained as a feature outputted by the encoder. As the feature extractor may be used a DNN trained by a technique such as self-supervised learning. The use of such a feature extractor enables the extraction unit 32 to obtain a surface condition feature appropriately indicating the condition of the road surface of the host vehicle lane even if there is an obstacle of indefinite color, shape, and size on the host vehicle lane.

Further, the extraction unit 32 may substitute a predetermined value for each pixel value of the image except the path region to mask the outside of the path region so that the feature extractor can determine a surface condition feature based only on the path region in the image. The extraction unit 32 inputs the image in which the outside of the path region is masked into the feature extractor. Alternatively, the extraction unit 32 may cut the path region out of the image, and input the cutout path region into the feature extractor. In this case, the extraction unit 32 may execute preprocessing, such as upsampling, downsampling, or padding, on the cutout path region so that the cutout path region has a predetermined shape and size. The extraction unit 32 may then input the preprocessed path region into the feature extractor. Since this makes the shape and size of the path region inputted into the feature extractor be uniform, the feature extractor can be simplified.

When a vehicle ahead traveling on the host vehicle lane is detected, the extraction unit 32 may further input a subregion in the path region corresponding to a section from the vehicle 10 to the vehicle ahead into the feature extractor. In other words, the extraction unit 32 inputs a subregion in the path region below the bottom of a vehicle-ahead region into the feature extractor. This prevents the vehicle ahead from affecting calculation of a surface condition feature.

The extraction unit 32 passes the extracted surface condition feature to the detection unit 33.

The detection unit 33 determines whether the surface condition feature received from the extraction unit 32 is within a normal range read from the memory 22. The normal range is a tolerable range of the surface condition feature in which the vehicle 10 is able to travel normally, as described above. The normal range is preset so as to include surface condition features extracted from a large number of images representing path regions where the vehicle 10 is able to travel normally, and so as not to include surface condition features extracted from a large number of images representing path regions where the vehicle 10 is unable to travel normally. When the surface condition feature extracted by the extraction unit 32 is outside the normal range, the detection unit 33 detects an abnormal condition in which the vehicle 10 is unable to travel normally on the host vehicle lane. When the surface condition feature is within the normal range, the detection unit 33 does not detect such an abnormal condition.

The detection unit 33 notifies the vehicle control unit 34 of the result of determination whether an abnormal condition is detected.

When notified by the detection unit 33 that an abnormal condition is detected, the vehicle control unit 34 controls components of the vehicle 10 so that the abnormal condition may not pose a danger to the vehicle 10. For example, when notified that an abnormal condition is detected, the vehicle control unit 34 decelerates the vehicle 10 at a predetermined deceleration.

The vehicle control unit 34 sets the degree of accelerator opening or the amount of braking so as to decelerate at the set deceleration. The vehicle control unit 34 then determines the amount of fuel injection according to the set degree of accelerator opening, and outputs a control signal depending on the amount of fuel injection to a fuel injector of an engine of the vehicle 10. Alternatively, the vehicle control unit 34 controls a power supply of a motor for driving the vehicle 10 so that electric power depending on the set degree of accelerator opening is supplied to the motor. Alternatively, the vehicle control unit 34 outputs a control signal depending on the set amount of braking to the brakes of the vehicle 10.

In addition, the vehicle control unit 34 may notify the driver of a warning that an abnormal condition is detected, via a notification device provided in the interior of the vehicle 10. For example, when a display is provided as an example of the notification device, the vehicle control unit 34 causes a warning message or an icon indicating that an abnormal condition is detected to appear on the display. When a speaker is provided as another example of the notification device, the vehicle control unit 34 causes the speaker to output a warning voice saying that an abnormal condition is detected. When a vibrator is provided in the driver's seat or steering as still another example of the notification device, the vehicle control unit 34 causes the vibrator to vibrate. When one or more light sources are provided as yet another example of the notification device, the vehicle control unit 34 causes a light source corresponding to detection of an abnormal condition among the light sources to light up or blink. When multiple notification devices are provided in the vehicle interior, the vehicle control unit 34 may give notification of a warning that an abnormal condition is detected, via two or more of the notification devices.

Alternatively, the vehicle control unit 34 may reduce the level of autonomous driving control applied to the vehicle 10. For example, when “level 3” autonomous driving control defined by the Society of Automotive Engineers (SAE) is applied to the vehicle 10, the vehicle control unit 34 reduces the level of autonomous driving control applied to the vehicle 10 to one of levels 0 to 2. When level 2 autonomous driving control is applied to the vehicle 10, the vehicle control unit 34 reduces the level of autonomous driving control applied to the vehicle 10 to level 0 or 1. Alternatively, the vehicle control unit 34 may request the driver of the vehicle 10 to hold the steering wheel. In this case also, the vehicle control unit 34 notifies the driver that the level of autonomous driving control will be changed, via the notification device provided in the interior of the vehicle 10. More specifically, when a display is provided as an example of the notification device, the vehicle control unit 34 causes a notification message or an icon indicating a change of the level of applied autonomous driving control and the level after the change to appear on the display. When a speaker is provided as another example of the notification device, the vehicle control unit 34 causes the speaker to output a notification voice saying about a change of the level of applied autonomous driving control and the level after the change. When a vibrator is provided in the driver's seat or steering as still another example of the notification device, the vehicle control unit 34 causes the vibrator to vibrate in a mode corresponding to the level of autonomous driving control to be applied. When one or more light sources are provided as yet another example of the notification device, the vehicle control unit 34 causes a light source corresponding to the level of autonomous driving control after the change among the light sources to light up or blink. When multiple notification devices are provided in the vehicle interior, the vehicle control unit 34 may give notification of a change of the level of applied autonomous driving control via two or more of the notification devices.

Alternatively, the vehicle control unit 34 may only notify the driver of a warning that an abnormal condition is detected, via the notification device provided in the vehicle interior, without decelerating the vehicle 10 and without changing the level of applied autonomous driving control.

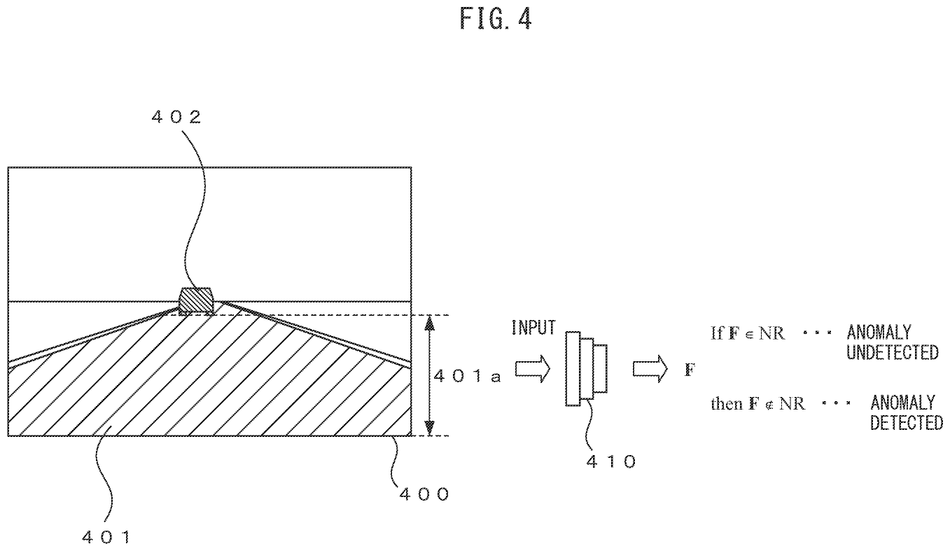

FIG. 4 illustrates an example of the anomaly detection process according to the present embodiment. In an image 400 illustrated in FIG. 4, a path region 401 representing a host vehicle lane is identified. In this example, since there is a vehicle ahead traveling on the host vehicle lane, a vehicle-ahead region 402 representing the vehicle ahead is also identified. The bottom of the vehicle-ahead region 402 is supposed to indicate the position of the rear edge or the rear wheels of the vehicle ahead. Thus, a subregion 401a in the path region 401 below the bottom of the vehicle-ahead region 402 is inputted into a feature extractor 410, and a surface condition feature F is extracted by the feature extractor 410. When the extracted surface condition feature F is within a normal range NR, no anomaly is detected. When the surface condition feature F is outside the normal range NR, an anomaly is detected.

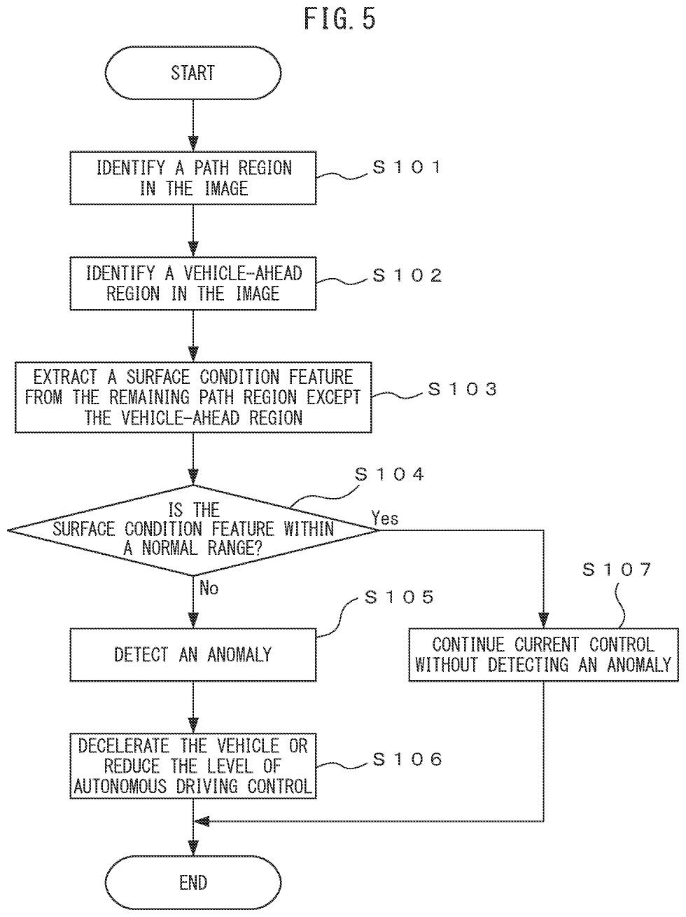

FIG. 5 is an operation flowchart of the vehicle control process including the anomaly detection process and executed by the processor 23. The processor 23 executes the vehicle control process at predetermined intervals in accordance with the operation flowchart described below.

The identification unit 31 of the processor 23 identifies a path region representing a host vehicle lane in the latest image obtained by the camera 2 (step S101). The identification unit 31 also identifies a vehicle-ahead region representing a vehicle ahead in the image (step S102).

The extraction unit 32 of the processor 23 extracts a surface condition feature from a subregion except the vehicle-ahead region in the path region in the image (step S103). The detection unit 33 of the processor 23 determines whether the surface condition feature is within a normal range (step S104). When the surface condition feature is outside the normal range (No in step S104), the detection unit 33 detects an abnormal condition in which the vehicle 10 is unable to travel normally on the host vehicle lane (step S105). The vehicle control unit 34 of the processor 23 decelerates the vehicle 10 or reduces the level of autonomous driving control applied to the vehicle 10 so that the detected abnormal condition may not pose a danger to the vehicle 10 (step S106).

When the surface condition feature is within the normal range in step S104 (Yes in step S104), the detection unit 33 does not detect an abnormal condition in which the vehicle 10 is unable to travel normally on the host vehicle lane. The vehicle control unit 34 continues control of the vehicle 10 currently applied to the vehicle 10 (step S107).

After step S106 or S107, the processor 23 terminates the vehicle control process.

As has been described above, the anomaly detection device identifies a path region representing a host vehicle lane in an image representing the surroundings of the vehicle generated by an image capturing unit mounted on the vehicle. In addition, the anomaly detection device extracts a surface condition feature by inputting the path region in the image into a feature extractor. The anomaly detection device determines whether the extracted surface condition feature is within a normal range in which the vehicle is able to travel normally, and detects an abnormal condition in which the vehicle is unable to travel normally on the host vehicle lane, when the feature is outside the normal range. In this way, the anomaly detection device can detect an abnormal condition accurately even if there is an obstacle of indefinite color, shape, and size, such as a fallen object or a defect of the road, on the host vehicle lane.

According to a modified example, the vehicle control unit 34 may change control applied to the vehicle 10, depending on the duration during which an abnormal condition is detected. For example, when the duration during which an abnormal condition is detected is less than a first period threshold, the vehicle control unit 34 warns the driver that an abnormal condition is detected, via the notification device. When the duration during which an abnormal condition is detected is not less than the first period threshold and less than a second period threshold (second period threshold>first period threshold), the vehicle control unit 34 reduces the level of autonomous driving control applied to the vehicle 10. In addition, when the duration during which an abnormal condition is detected is not less than the second period threshold, the vehicle control unit 34 decelerates the vehicle 10. By changing control applied to the vehicle 10 in this way, depending on the duration during which an abnormal condition is detected, the vehicle control unit 34 can control the vehicle 10 more appropriately so as not to pose a danger to the vehicle 10.

According to another modified example, when the surface condition feature is outside the normal range, the vehicle control unit 34 may change control applied to the vehicle 10, depending on the distance from the surface condition feature to the normal range. For example, when the distance from the surface condition feature to the normal range is less than a first distance threshold, the vehicle control unit 34 warns the driver that an abnormal condition is detected, via the notification device. When the distance from the surface condition feature to the normal range is not less than the first distance threshold and less than a second distance threshold (second distance threshold>first distance threshold), the vehicle control unit 34 reduces the level of autonomous driving control applied to the vehicle 10. In addition, when the distance from the surface condition feature to the normal range is not less than the second distance threshold, the vehicle control unit 34 decelerates the vehicle 10. By changing control applied to the vehicle 10 in this way, depending on the distance from the surface condition feature to the normal range, the vehicle control unit 34 can control the vehicle 10 more appropriately so as not to pose a danger to the vehicle 10.

The computer program for achieving the functions of the processor 23 of the ECU 3 according to the embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present disclosure.

What is claimed is:

1. An anomaly detection device comprising:
a processor configured to:
identify a path region in an image representing surroundings of a vehicle, the path region representing a host vehicle lane on which the vehicle is traveling,
extract a feature indicating a condition of a road surface regarding the path region from the image by inputting the path region into a feature extractor that has been trained to extract the feature, and
detect an abnormal condition in which the vehicle is unable to travel normally on the host vehicle lane, when the feature is outside a normal range that is a tolerable range in which the vehicle is able to travel normally.

2. The anomaly detection device according to claim 1, wherein the processor extracts the feature by inputting an area in the path region below the bottom of a vehicle-ahead region into the feature extractor, the vehicle-ahead region representing a vehicle traveling ahead of the vehicle.

3. An anomaly detection method comprising:
identifying a path region in an image representing surroundings of a vehicle, the path region representing a host vehicle lane on which the vehicle is traveling;
extracting a feature indicating a condition of a road surface regarding the path region from the image by inputting the path region into a feature extractor that has been trained to extract the feature; and
detecting an abnormal condition in which the vehicle is unable to travel normally on the host vehicle lane, when the feature is outside a normal range that is a tolerable range in which the vehicle is able to travel normally.

4. A non-transitory recording medium that stores a computer program for detecting an anomaly, the computer program causing a processor mounted on a vehicle to execute a process comprising:
identifying a path region in an image representing surroundings of the vehicle, the path region representing a host vehicle lane on which the vehicle is traveling;
extracting a feature indicating a condition of a road surface regarding the path region from the image by inputting the path region into a feature extractor that has been trained to extract the feature; and
detecting an abnormal condition in which the vehicle is unable to travel normally on the host vehicle lane, when the feature is outside a normal range that is a tolerable range in which the vehicle is able to travel normally.
